(19) United States
(12) Patent Application Publication
(10) Pub. No.: US 2019/0341053 A1
(43) Pub. Date: Nov. 7, 2019

(54) MULTI-MODAL SPEECH ATTRIBUTION AMONG N SPEAKERS

(71) Applicant: Microsoft Technology Licensing, LLC, Redmond, WA (US)

(72) Inventors: Shixiong ZHANG, Redmond, WA (US); Lingfeng WU, Bothell, WA (US); Eyal KRUPKA, Redmond, WA (US); Xiong XIAO, Bothell, WA (US); Yifan GONG, Sammamish, WA (US)

(73) Assignee: Microsoft Technology Licensing, LLC, Redmond, WA (US)

(21) Appl. No.: 16/019,318

(22) Filed: Jun. 26, 2018

Related U.S. Application Data
(60) Provisional application No. 62/667,562, filed on May 6, 2018.
(60) Provisional application No. 62/667,564, filed on May 6, 2018.

(51) Int. Cl. G10L 17/00; G06K 9/00; H04R 1/40; G06K 9/62; H04L 12/18

(52) U.S. Cl. CPC G10L 17/005; G06K 9/00228; H04L 12/1813; G06K 9/6262; G06K 9/00288; H04R 1/406

(57) ABSTRACT

A computerized conference assistant includes a camera and a microphone. A face location machine of the computerized conference assistant finds a physical location of a human, based on a position of a candidate face in digital video captured by the camera. A beamforming machine of the computerized conference assistant outputs a beamformed signal isolating sounds originating from the physical location of the human. A diarization machine of the computerized conference assistant attributes information encoded in the beamformed signal to the human.

### CROSS REFERENCE TO RELATED APPLICATIONS

This application claims priority to U.S. Provisional Patent Application Ser. No. 62/667,562, filed May 6, 2018, and to U.S. Provisional Patent Application Ser. No. 62/667,564, filed May 6, 2018, the entirety of each of which are hereby incorporated herein by reference for all purposes.

### BACKGROUND

Human speech may be converted to text using machine learning technologies. However, in environments that include two or more speakers, state-of-the-art speech recognizers are unable to reliably associate speech with the correct speaker.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A computerized conference assistant includes a camera and a microphone. A face location machine of the computerized conference assistant finds a physical location of a human, based on a position of a candidate face in digital video captured by the camera. A beamforming machine of the computerized conference assistant outputs a beamformed signal isolating sounds originating from the physical location of the human. A diarization machine of the computerized conference assistant attributes information encoded in the beamformed signal to the human.

### BRIEF DESCRIPTION OF THE DRAWINGS

FIG. 1A-1C depict a computing environment including an exemplary computerized conference assistant.

FIG. 2 schematically shows analysis of sound signals by a sound source localization machine.

FIG. 3 schematically shows beamforming of sound signals by a beamforming machine.

FIG. 4 schematically shows detection of human faces by a face detection machine.

FIG. 5 schematically shows identification of human faces by a face identification machine.

FIG. 6 schematically shows an exemplary diarization framework.

FIG. 7 is a visual representation of an example output of a diarization machine.

FIG. 8 schematically shows recognition of an utterance by a speech recognition machine.

FIG. 9 shows an example of diarization by a computerized conference assistant.

FIG. 10 shows an example conference transcript.

FIG. 11 schematically shows an exemplary diarization framework in which speech recognition machines are downstream from a diarization machine.

FIG. 12 schematically shows an exemplary diarization framework in which speech recognition machines are upstream from a diarization machine.

FIG. 13 shows an example method of attributing speech between a plurality of different speakers.

### DETAILED DESCRIPTION

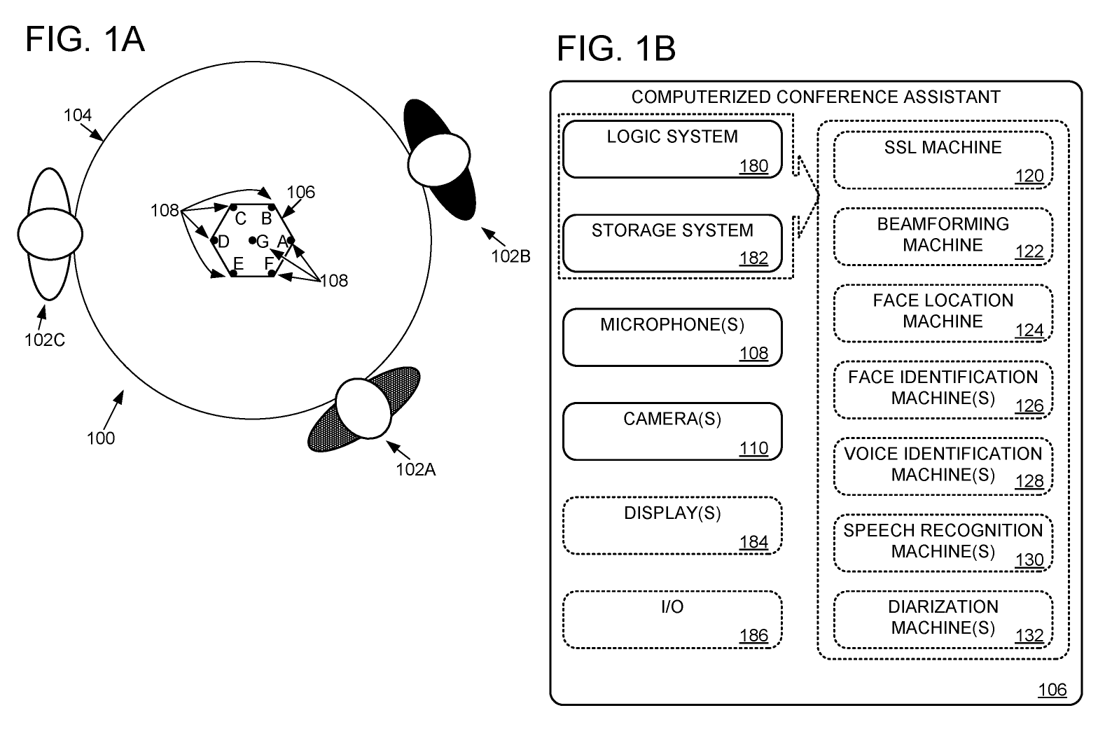

FIG. 1 shows an example conference environment 100 including three conference participants 102A, 102B, and 102C meeting around a table 104. A computerized conference assistant 106 is on table 104 ready to facilitate a meeting between the conference participants. Computerized conference assistants consistent with this disclosure may be configured with a myriad of features designed to facilitate productive meetings. However, the following description primarily focusses on features pertaining to associating recorded speech with the appropriate speaker. While the following description uses computerized conference assistant 106 as an example computer configured to attribute speech to the correct speaker, other computers or combinations of computers utilizing any number of different microphone and/or camera configurations may be configured to utilize the techniques described below. As such, the present disclosure is in no way limited to computerized conference assistant 106.

FIG. 1B schematically shows relevant aspects of computerized conference assistant 106, each of which is discussed below. Of particular relevance, computerized conference assistant 106 includes microphone(s) 108 and camera(s) 110.

As shown in FIG. 1A, the computerized conference assistant 106 includes an array of seven microphones 108A, 108B, 108C, 108D, 108E, 108F, and 108G. As shown in FIG. 1C, these microphones 108 are configured to record sound and convert the audible sound into a computer-readable audio signal 112 (i.e., signals 112a, 112b, 112c, 112d, 112e, 112f, and 112g respectively). An analog to digital converter and optional digital encoders may be used to convert the sound into the computer-readable audio signals. Microphones 108A-F are equally spaced around the computerized conference assistant 106 and aimed in different horizontal directions. Microphone 108g is positioned between the other microphones and aimed upward. Microphones 108 may be directional, omnidirectional, or a combination of directional and omnidirectional.

In some implementations, computerized conference assistant 106 includes a 360° camera configured to convert light of one or more electromagnetic bands (e.g., visible, infrared, and/or near infrared) into a 360° digital video 114 or other suitable visible, infrared, near infrared, spectral, and/or depth digital video. In some implementations, the 360° camera may include fisheye optics that redirect light from all azimuthal angles around the computerized conference assistant 106 to a single matrix of light sensors, and logic for mapping the independent measurements from the sensors to a corresponding matrix of pixels in the 360° digital video 114. In some implementations, two or more cooperating cameras may take overlapping sub-images that are stitched together into digital video 114. In some implementations, camera(s) 110 have a collective field of view of less than 360° and/or two or more originating perspectives (e.g., cameras pointing toward a center of the room from the four corners of the room). 360° digital video 114 is shown as being substantially rectangular without appreciable geometric distortion, although this is in no way required.

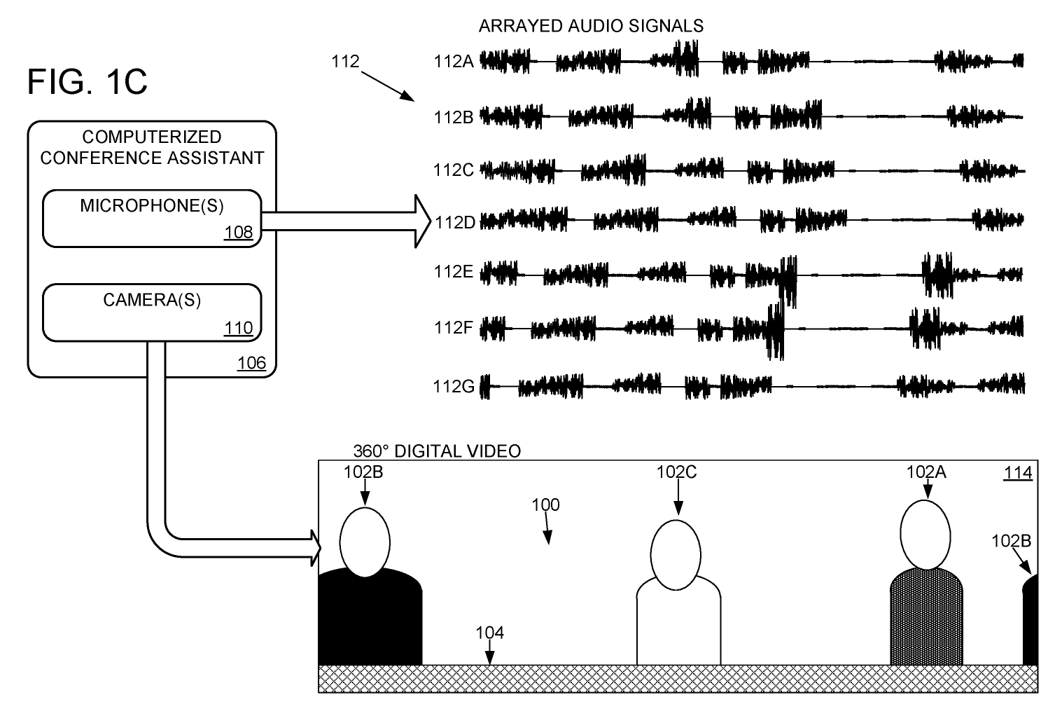

Returning briefly to FIG. 1B, computerized conference assistant 106 includes a sound source localization (SSL) machine 120 that is configured to estimate the location(s) of sound(s) based on signals 112. FIG. 2 schematically shows SSL machine 120 analyzing signals 112a-g to output an estimated origination 140 of the sound modeled by signals 112a-g. As introduced above, signals 112a-g are respectively generated by microphones 108a-g. Each microphone has a different physical position and/or is aimed in a different direction. Microphones that are farther from a sound source and/or aimed away from a sound source will generate a relatively lower amplitude and/or slightly phase delayed signal 112 relative to microphones that are closer to and/or aimed toward the sound source. As an example, while microphones 108a and 108d may respectively produce signals 112a and 112d in response to the same sound, signal 112a may have a measurably greater amplitude if the recorded sound originated in front of microphone 108a. Similarly, signal 112d may be phase shifted behind signal 112a due to the longer time of flight (ToF) of the sound to microphone 108d. SSL machine 120 may use the amplitude, phase difference, and/or other parameters of the signals 112a-g to estimate the origination 140 of a sound. SSL machine 120 may be configured to implement any suitable two- or three-dimensional location algorithms, including but not limited to previously-trained artificial neural networks, maximum likelihood algorithms, multiple signal classification algorithms, and cross-power spectrum phase analysis algorithms. Depending on the algorithm(s) used in a particular application, the SSL machine 120 may output an angle, vector, coordinate, and/or other parameter estimating the origination 140 of a sound.

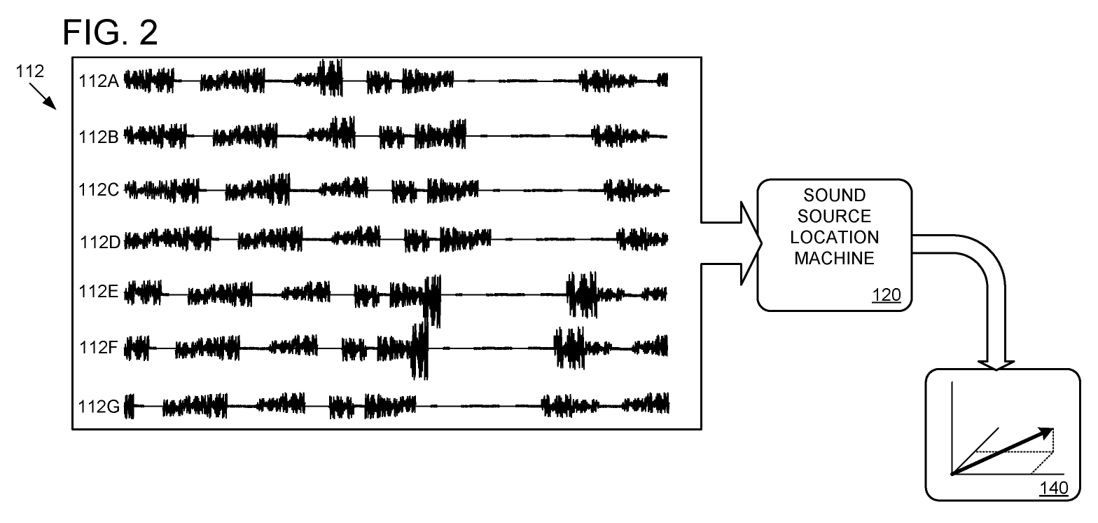

As shown in FIG. 1B, computerized conference assistant 106 also includes a beamforming machine 122. The beamforming machine 122 may be configured to isolate sounds originating in a particular zone (e.g., a 0-60° arc) from sounds originating in other zones. In the embodiment depicted in FIG. 3, beamforming machine 122 is configured to isolate sounds in any of six equally-sized static zones. In other implementations, there may be more or fewer static zones, dynamically sized zones (e.g., a focused 15° arc), and/or dynamically aimed zones (e.g., a 60° zone centered at 9°). Any suitable beamforming signal processing may be utilized to subtract sounds originating outside of a selected zone from a resulting beamformed signal 150. In implementations that utilize dynamic beamforming, the location of the various speakers may be used as criteria for selecting the number, size, and centering of the various beamforming zones. As one example, the number of zones may be selected to equal the number of speakers, and each zone may be centered on the location of the speaker (e.g., as determined via face identification and/or sound source localization). In some implementations beamforming machine may be configured to independently and simultaneously listen to two or more different zones, and output two or more different beamformed signals in parallel. As such, two or more overlapping/interrupting speakers may be independently processed.

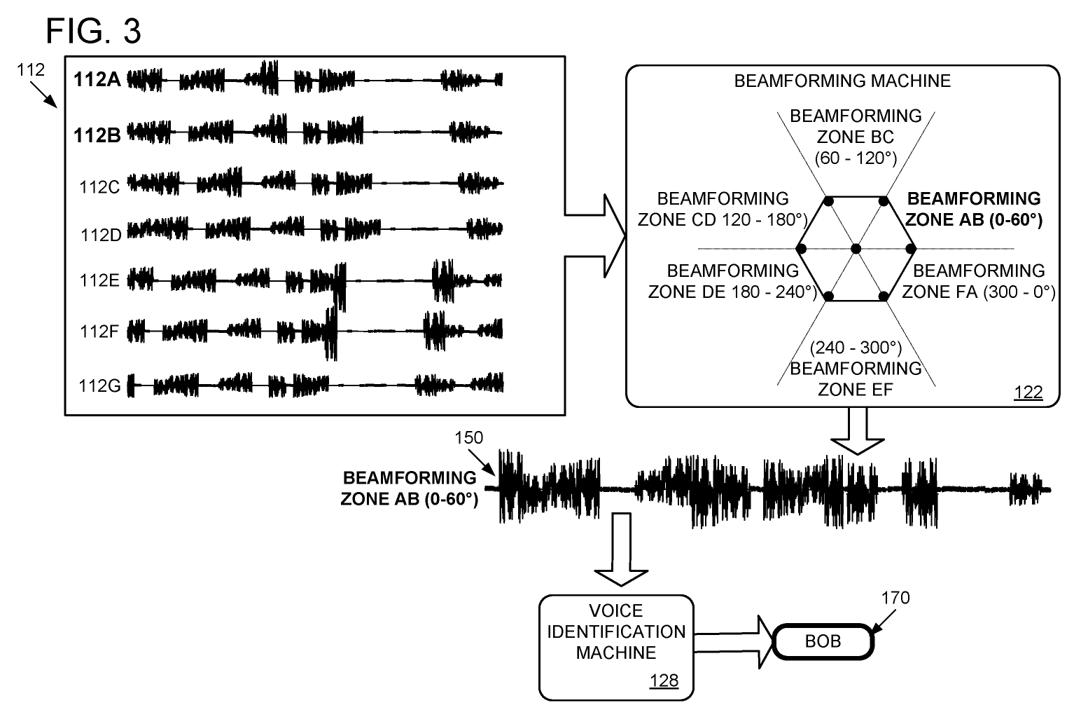

As shown in FIG. 1B, computerized conference assistant 106 includes a face location machine 124 and a face identification machine 126. As shown in FIG. 4, face location machine 124 is configured to find candidate faces 166 in digital video 114. As an example, FIG. 4 shows face location machine 124 finding candidate FACE(1) at 23°, candidate FACE(2) at 178°, and candidate FACE(3) at 303°. The candidate faces 166 output by the face location machine 124 may include coordinates of a bounding box around a located face image, a portion of the digital image where the face was located, other location information (e.g., 23°), and/or labels (e.g., “FACE(1)”).

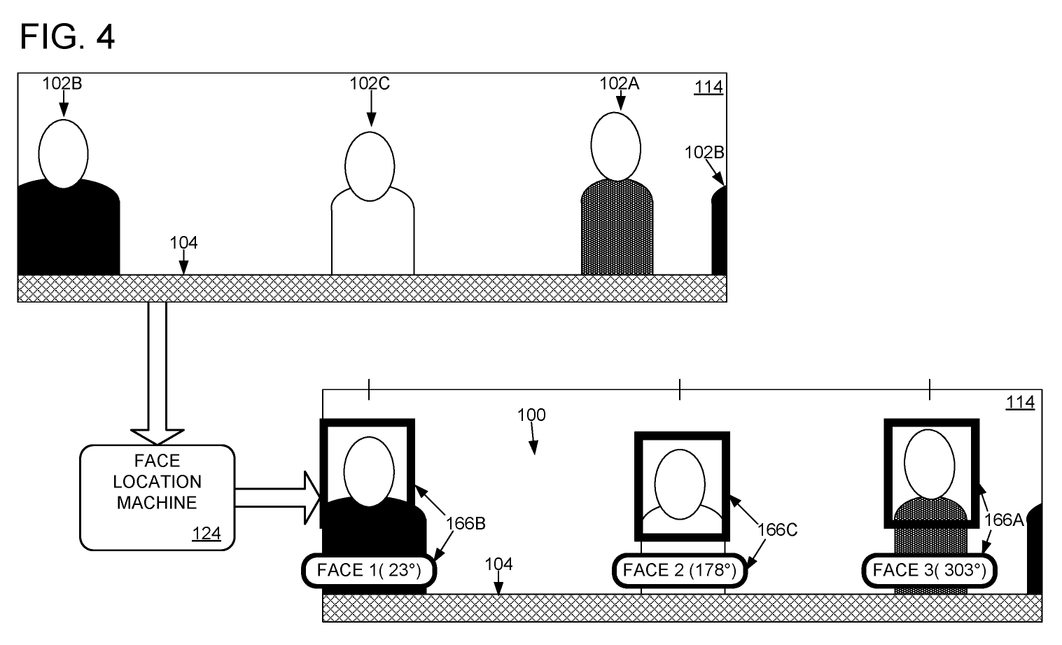

Face identification machine 126 optionally may be configured to determine an identity 168 of each candidate face 166 by analyzing just the portions of the digital video 114 where candidate faces 166 have been found. In other implementations, the face location step may be omitted, and the face identification machine may analyze a larger portion of the digital video 114 to identify faces. FIG. 5 shows an example in which face identification machine 126 identifies candidate FACE(1) as “Bob,” candidate FACE(2) as “Charlie,” and candidate FACE(3) as “Alice.” While not shown, each identity 168 may have an associated confidence value, and two or more different identities 168 having different confidence values may be found for the same face (e.g., Bob (88%), Bert (33%)). If an identity with at least a threshold confidence cannot be found, the face may remain unidentified and/or may be given a generic unique identity 168 (e.g., “Guest (42)”). Speech may be attributed to such generic unique identities.

When used, face location machine 124 may employ any suitable combination of state-of-the-art and/or future machine learning (ML) and/or artificial intelligence (AI) techniques. Non-limiting examples of techniques that may be incorporated in an implementation of face location machine 124 include support vector machines, multi-layer neural networks, convolutional neural networks (e.g., including spatial convolutional networks for processing images and/or videos), recurrent neural networks (e.g., long short-term memory networks), associative memories (e.g., lookup tables, hash tables, Bloom Filters, Neural Turing Machine and/or Neural Random Access Memory), unsupervised spatial and/or clustering methods (e.g., nearest neighbor algorithms, topological data analysis, and/or k-means clustering) and/or graphical models (e.g., Markov models, conditional random fields, and/or AI knowledge bases).

In some examples, the methods and processes utilized by face location machine 124 may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters may be adjusted through any suitable training procedure, in order to continually improve functioning of the face location machine 124.

Non-limiting examples of training procedures for face location machine 124 include supervised training (e.g., using gradient descent or any other suitable optimization method), zero-shot, few-shot, unsupervised learning methods (e.g., classification based on classes derived from unsupervised clustering methods), reinforcement learning (e.g., deep Q learning based on feedback) and/or based on generative adversarial neural network training methods. In some examples, a plurality of components of face location machine 124 may be trained simultaneously with regard to an objective function measuring performance of collective functioning of the plurality of components (e.g., with regard to reinforcement feedback and/or with regard to labelled training data), in order to improve such collective functioning. In some examples, one or more components of face location machine 124 may be trained independently of other components (e.g., offline training on historical data). For example, face location machine 124 may be trained via supervised training on labelled training data comprising images with labels indicating any face(s) present within such images, and with regard to an objective function measuring an accuracy, precision, and/or recall of locating faces by face location machine 124 as compared to actual locations of faces indicated in the labelled training data.

In some examples, face location machine 124 may employ a convolutional neural network configured to convolve inputs with one or more predefined, randomized and/or learned convolutional kernels. By convolving the convolutional kernels with an input vector (e.g., representing digital video 114), the convolutional neural network may detect a feature associated with the convolutional kernel. For example, a convolutional kernel may be convolved with an input image to detect low-level visual features such as lines, edges, corners, etc., based on various convolution operations with a plurality of different convolutional kernels. Convolved outputs of the various convolution operations may be processed by a pooling layer (e.g., max pooling) which may detect one or more most salient features of the input image and/or aggregate salient features of the input image, in order to detect salient features of the input image at particular locations in the input image. Pooled outputs of the pooling layer may be further processed by further convolutional layers. Convolutional kernels of further convolutional layers may recognize higher-level visual features, e.g., shapes and patterns, and more generally spatial arrangements of lower-level visual features. Some layers of the convolutional neural network may accordingly recognize and/or locate visual features of faces (e.g., noses, eyes, lips). Accordingly, the convolutional neural network may recognize and locate faces in the input image. Although the foregoing example is described with regard to a convolutional neural network, other neural network techniques may be able to detect and/or locate faces and other salient features based on detecting low-level visual features, higher-level visual features, and spatial arrangements of visual features.

Face identification machine 126 may employ any suitable combination of state-of-the-art and/or future ML and/or AI techniques. Non-limiting examples of techniques that may be incorporated in an implementation of face identification machine 126 include support vector machines, multi-layer neural networks, convolutional neural networks, recurrent neural networks, associative memories, unsupervised spatial and/or clustering methods, and/or graphical models.

In some examples, face identification machine 126 may be implemented using one or more differentiable functions and at least partially determined by a set of trainable parameters. Accordingly, the trainable parameters may be adjusted through any suitable training procedure, in order to continually improve functioning of the face identification machine 126.

Non-limiting examples of training procedures for face identification machine 126 include supervised training, zero-shot, few-shot, unsupervised learning methods, reinforcement learning and/or generative adversarial neural network training methods. In some examples, a plurality of components of face identification machine 126 may be trained simultaneously with regard to an objective function measuring performance of collective functioning of the plurality of components in order to improve such collective functioning. In some examples, one or more components of face identification machine 126 may be trained independently of other components.

In some examples, face identification machine 126 may employ a convolutional neural network configured to detect and/or locate salient features of input images. In some examples, face identification machine 126 may be trained via supervised training on labelled training data comprising images with labels indicating a specific identity of any face(s) present within such images, and with regard to an objective function measuring an accuracy, precision, and/or recall of identifying faces by face identification machine 126 as compared to actual identities of faces indicated in the labelled training data. In some examples, face identification machine 126 may be trained via supervised training on labelled training data comprising pairs of face images with labels indicating whether the two face images in a pair are images of a single individual or images of two different individuals, and with regard to an objective function measuring an accuracy, precision, and/or recall of distinguishing single-individual pairs from two-different-individual pairs.

In some examples, face identification machine 126 may be configured to classify faces by selecting and/or outputting a confidence value for an identity from a predefined selection of identities, e.g., a predefined selection of identities for whom face images were available in training data used to train face identification machine 126. In some examples, face identification machine 126 may be configured to assess a feature vector representing a face, e.g., based on an output of a hidden layer of a neural network employed in face identification machine 126. Feature vectors assessed by face identification machine 126 for a face image may represent an embedding of the face image in a representation space learned by face identification machine 126. Accordingly, feature vectors may represent salient features of faces based on such embedding in the representation sp ace.

In some examples, face identification machine 126 may be configured to enroll one or more individuals for later identification. Enrollment by face identification machine 126 may include assessing a feature vector representing the individual's face, e.g., based on an image and/or video of the individual's face. In some examples, identification of an individual based on a test image may be based on a comparison of a test feature vector assessed by face identification machine 126 for the test image, to a previously-assessed feature vector from when the individual was enrolled for later identification. Comparing a test feature vector to a feature vector from enrollment may be performed in any suitable fashion, e.g., using a measure of similarity such as cosine or inner product similarity, and/or by unsupervised spatial and/or clustering methods (e.g., approximative k-nearest neighbor methods). Comparing the test feature vector to the feature vector from enrollment may be suitable for assessing identity of individuals represented by the two vectors, e.g., based on comparing salient features of faces represented by the vectors.

As shown in FIG. 1B, computerized conference assistant 106 includes a voice identification machine 128. The voice identification machine 128 is analogous to the face identification machine 126 because it also attempts to identify an individual. However, unlike the face identification machine 126, which is trained on and operates on video images, the voice identification machine is trained on and operates on audio signals, such as beamformed signal 150 and/or signal(s) 112. The ML and AI techniques described above may be used by voice identification machine 128. The voice identification machine outputs voice IDs 170, optionally with corresponding confidences (e.g., Bob (77%)).

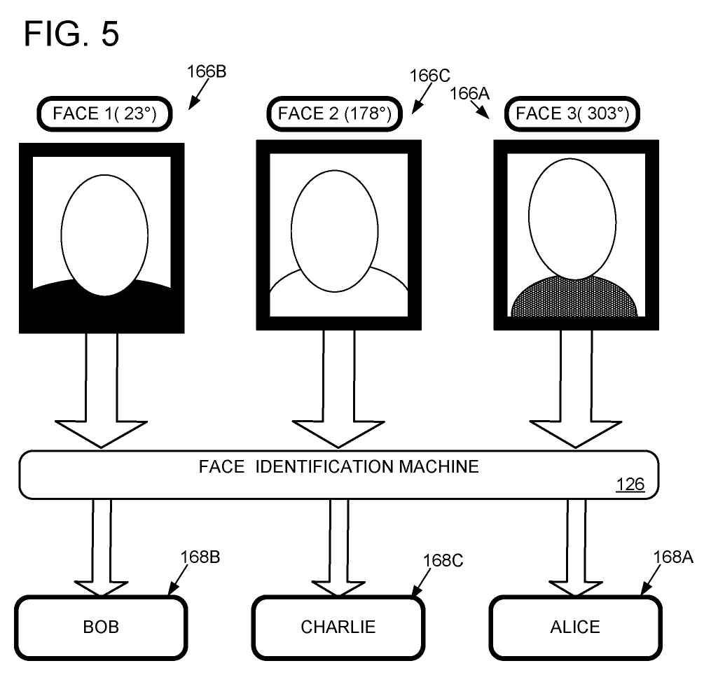

FIG. 6 schematically shows an example diarization framework 600 for the above-discussed components of computerized conference assistant 106. While diarization framework 600 is described below with reference to computerized conference assistant 106, the diarization framework may be implemented using different hardware, firmware, and/or software components (e.g., different microphone and/or camera placements and/or configurations). Furthermore, SSL machine 120, beamforming machine 122, face location machine 124, and/or face identification machine 128 may be used in different sensor fusion frameworks designed to associate speech utterances with the correct speaker.

In the illustrated implementation, microphones 108 provide signals 112 to SSL machine 120 and beamforming machine 122, and the SLL machine outputs origination 140 to diarization machine 132. In some implementations, origination 140 optionally may be output to Beamforming machine 122. Camera 110 provides 360° digital videos 114 to face location machine 124 and face identification machine 126. The face location machine passes the locations of candidate faces 166 (e.g., 23°) to the beamforming machine 122, which the beamforming machine may utilize to select a desired zone where a speaker has been identified. The beamforming machine 122 passes beamformed signal 150 to diarization machine 132 and to voice identification machine 128, which passes voice ID 170 to the diarization machine 132. Face identification machine 128 outputs identities 168 (e.g., “Bob”) with corresponding locations of candidate faces (e.g., 23°) to the diarization machine. While not shown, the diarization machine may receive other information and use such information to attribute speech utterances with the correct speaker.

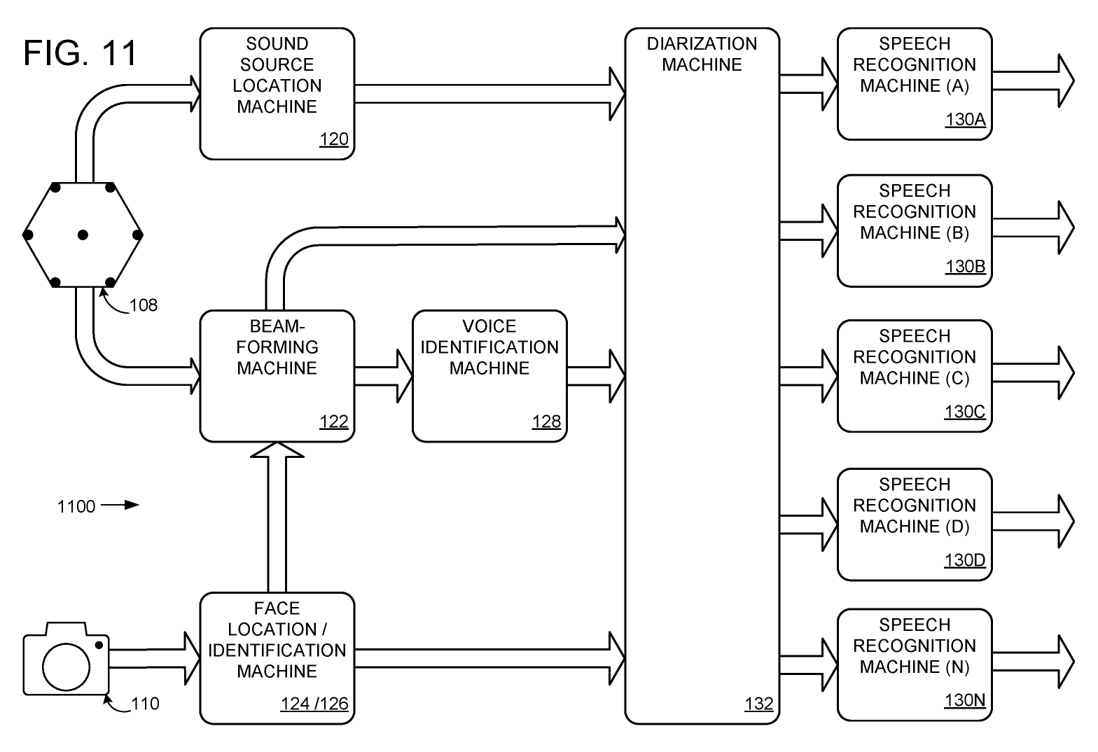

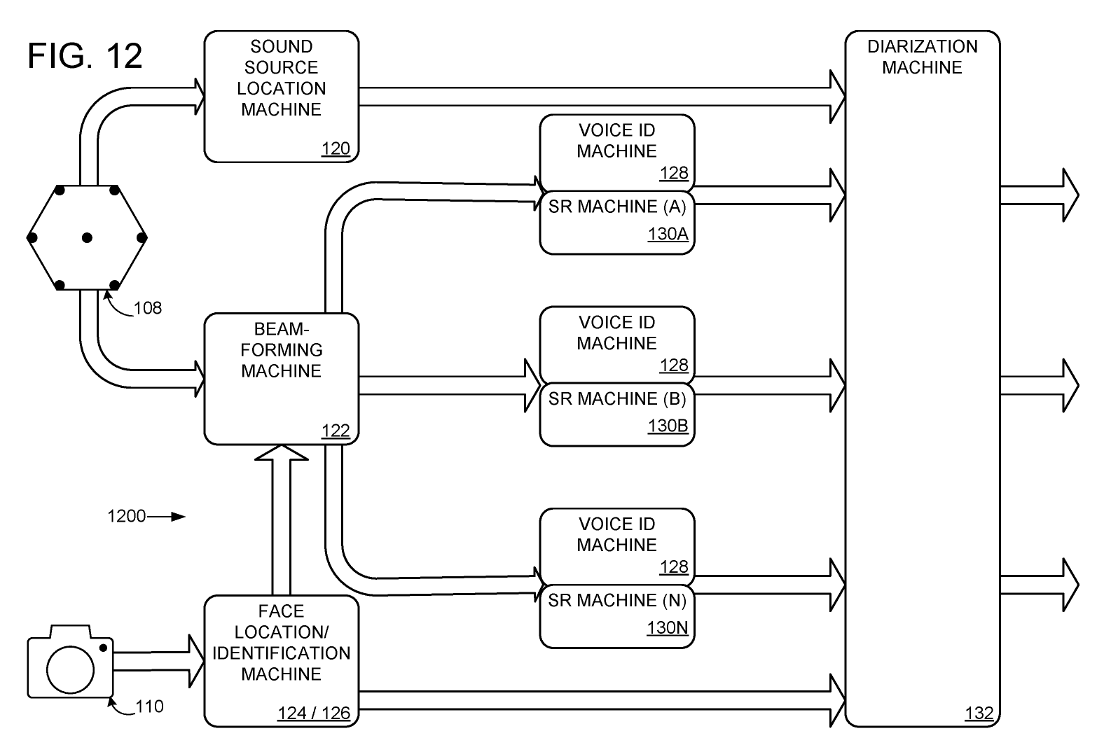

Diarization machine 132 is a sensor fusion machine configured to use the various received signals to associate recorded speech with the appropriate speaker. The diarization machine is configured to attribute information encoded in the beamformed signal or another audio signal to the human responsible for generating the corresponding sounds/speech. In some implementations (e.g., FIG. 11), the diarization machine is configured to attribute the actual audio signal to the corresponding speaker (e.g., label the audio signal with the speaker identity). In some implementations (e.g., FIG. 12), the diarization machine is configured to attribute speech-recognized text to the corresponding speaker (e.g., label the text with the speaker identity).

In one nonlimiting example, the following algorithm may be employed:

Video input (e.g., 360° digital video 114) from start to time t is denoted as V_{1:t}
Audio input from N microphones (e.g., signals 112) is denoted as A_{1:t}^{[1:N]}
Diarization machine 132 solves WHO is speaking, at WHERE and WHEN, by maximizing the following:

$${max}_{who , angle} P ( who , angle \vert {A}_{1 : t}^{[ 1 : N ]} , {V}_{1 : t} )$$

Where P (who, angle|A_{1:t}^{[1:N]}, V_{1:t}) is computed by P (who|A_{1:t}^{[1:N]}, angle)×P (angle|A_{1:t}^{[1:N]})×P (who, angle|V_{1:t})
   Where P (who|A_{1:t}^{[1:N]}, angle) is the Voice ID 170, which takes N channel inputs and selects one beamformed signal 150 according to the angle of candidate face 166;
   P (angle|A_{1:t}^{[1:N]}) is the origination 140, which takes N channel inputs and predicts which angle most likely has sound;
   P (who, angle|V_{1:t}) is the identity 168, which takes the video 114 as input and predicts the probability of each face showing up at each angle.

The above framework may be adapted to use any suitable processing strategies, including but not limited to the ML/AI techniques discussed above. Using the above framework, the probability of one face at the found angle is usually dominative, e.g., probability of Bob's face at 23° is 99%, and the probabilities of his face at all the other angles is almost 0%.

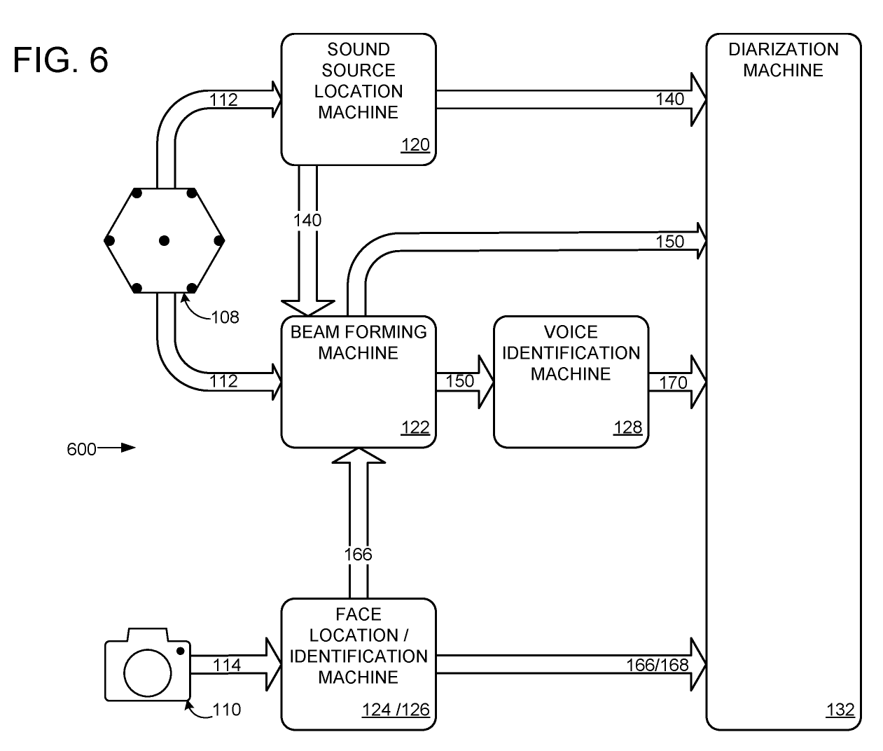

FIG. 7 is a visual representation of an example output of diarization machine 132. In FIG. 6, a vertical axis is used to denote WHO (e.g., Bob) is speaking; the horizontal axis denotes WHEN (e.g., 30.01 s-34.87 s) that speaker is speaking; and the depth axis denotes from WHERE (e.g., 23°) that speaker is speaking. Diarization machine 132 may use this WHO/WHEN/WHERE information to label corresponding segments 604 of the audio signal(s) 606 under analysis with labels 608. The segments 604 and/or corresponding labels may be output from the diarization machine 132 in any suitable format. The output effectively associates speech with a particular speaker during a conversation among N speakers, and allows the audio signal corresponding to each speech utterance (with WHO/WHEN/WHERE labeling/metadata) to be used for myriad downstream operations. One nonlimiting downstream operation is conversation transcription, as discussed in more detail below. As another example, accurately attributing speech utterances with the correct speaker can be used by an AI assistant to identify who is talking, thus decreasing a necessity for speakers to address an AI assistant with a keyword (e.g., “Cortana”).

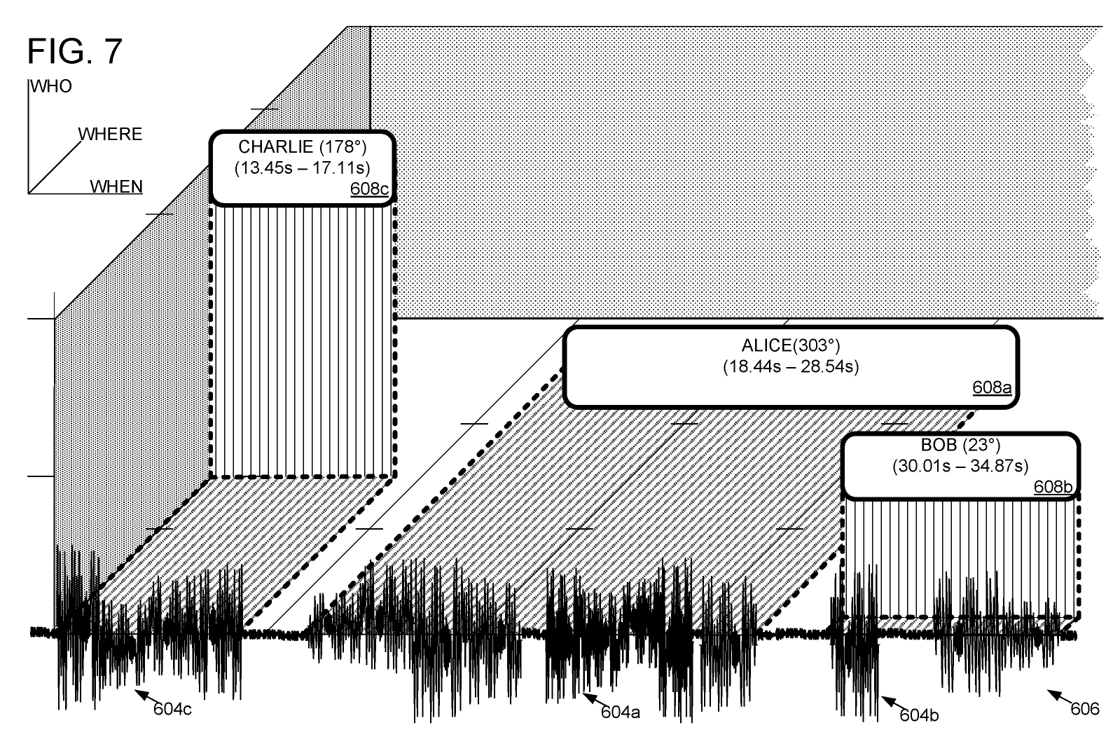

Returning briefly to FIG. 1B, computerized conference assistant 106 may include a speech recognition machine 130. As shown in FIG. 8, the speech recognition machine 130 may be configured to translate an audio signal of recorded speech (e.g., signals 112, beamformed signal 150, signal 606, and/or segments 604) into text 800. In the scenario illustrated in FIG. 8, speech recognition machine 130 translates signal 802 into the text: “Shall we play a game?”

Speech recognition machine 130 may employ any suitable combination of state-of-the-art and/or future natural language processing (NLP), AI, and/or ML techniques. Non-limiting examples of techniques that may be incorporated in an implementation of speech recognition machine 130 include support vector machines, multi-layer neural networks, convolutional neural networks (e.g., including temporal convolutional neural networks for processing natural language sentences), word embedding models (e.g., GloVe or Word2Vec), recurrent neural networks, associative memories, unsupervised spatial and/or clustering methods, graphical models, and/or natural language processing techniques (e.g., tokenization, stemming, constituency and/or dependency parsing, and/or intent recognition).

In some examples, speech recognition machine 130 may be implemented using one or more differentiable functions and at least partially determined by a set of trainable parameters. Accordingly, the trainable parameters may be adjusted through any suitable training procedure, in order to continually improve functioning of the speech recognition machine 130.

Non-limiting examples of training procedures for speech recognition machine 130 include supervised training, zero-shot, few-shot, unsupervised learning methods, reinforcement learning and/or generative adversarial neural network training methods. In some examples, a plurality of components of speech recognition machine 130 may be trained simultaneously with regard to an objective function measuring performance of collective functioning of the plurality of components in order to improve such collective functioning. In some examples, one or more components of speech recognition machine 130 may be trained independently of other components. In an example, speech recognition machine 130 may be trained via supervised training on labelled training data comprising speech audio annotated to indicate actual lexical data (e.g., words, phrases, and/or any other language data in textual form) corresponding to the speech audio, with regard to an objective function measuring an accuracy, precision, and/or recall of correctly recognizing lexical data corresponding to speech audio.

In some examples, speech recognition machine 130 may use an AI and/or ML model (e.g., an LSTM and/or a temporal convolutional neural network) to represent speech audio in a computer-readable format. In some examples, speech recognition machine 130 may represent speech audio input as word embedding vectors in a learned representation space shared by a speech audio model and a word embedding model (e.g., a latent representation space for GloVe vectors, and/or a latent representation space for Word2Vec vectors). Accordingly, by representing speech audio inputs and words in the learned representation space, speech recognition machine 130 may compare vectors representing speech audio to vectors representing words, to assess, for a speech audio input, a closest word embedding vector (e.g., based on cosine similarity and/or approximative k-nearest neighbor methods or any other suitable comparison method).

In some examples, speech recognition machine 130 may be configured to segment speech audio into words (e.g., using LSTM trained to recognize word boundaries, and/or separating words based on silences or amplitude differences between adjacent words). In some examples, speech recognition machine 130 may classify individual words to assess lexical data for each individual word (e.g., character sequences, word sequences, n-grams). In some examples, speech recognition machine 130 may employ dependency and/or constituency parsing to derive a parse tree for lexical data. In some examples, speech recognition machine 130 may operate AI and/or ML models (e.g., LSTM) to translate speech audio and/or vectors representing speech audio in the learned representation space, into lexical data, wherein translating a word in the sequence is based on the speech audio at a current time and further based on an internal state of the AI and/or ML models representing previous words from previous times in the sequence. Translating a word from speech audio to lexical data in this fashion may capture relationships between words that are potentially informative for speech recognition, e.g., recognizing a potentially ambiguous word based on a context of previous words, and/or recognizing a mispronounced word based on a context of previous words. Accordingly, speech recognition machine 130 may be able to robustly recognize speech, even when such speech may include ambiguities, mispronunciations, etc.

Speech recognition machine 130 may be trained with regard to an individual, a plurality of individuals, and/or a population. Training speech recognition machine 130 with regard to a population of individuals may cause speech recognition machine 130 to robustly recognize speech by members of the population, taking into account possible distinct characteristics of speech that may occur more frequently within the population (e.g., different languages of speech, speaking accents, vocabulary, and/or any other distinctive characteristics of speech that may vary between members of populations). Training speech recognition machine 130 with regard to an individual and/or with regard to a plurality of individuals may further tune recognition of speech to take into account further differences in speech characteristics of the individual and/or plurality of individuals. In some examples, different speech recognition machines (e.g., a speech recognition machine (A) and a speech recognition (B)) may be trained with regard to different populations of individuals, thereby causing each different speech recognition machine to robustly recognize speech by members of different populations, taking into account speech characteristics that may differ between the different populations.

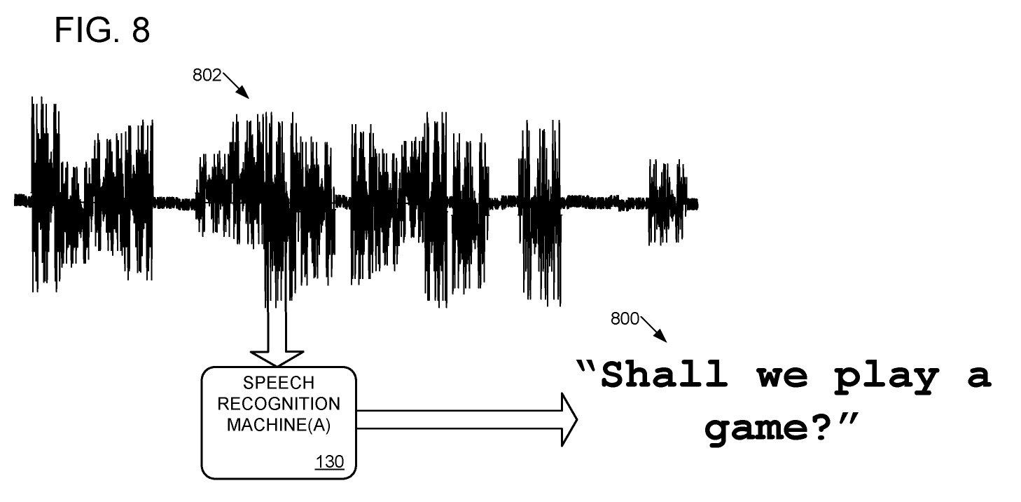

Labeled and/or partially labelled audio segments may be used to not only determine which of a plurality of N speakers is responsible for an utterance, but also translate the utterance into a textural representation for downstream operations, such as transcription. FIG. 9 shows a nonlimiting example in which the computerized conference assistant 106 uses microphones 108 and camera 110 to determine that a particular stream of sounds is a speech utterance from Bob, who is sitting at 23° around the table 104 and saying: “Shall we play a game?” The identities and positions of Charlie and Alice are also resolved, so that speech utterances from those speakers may be similarly attributed and translated into text.

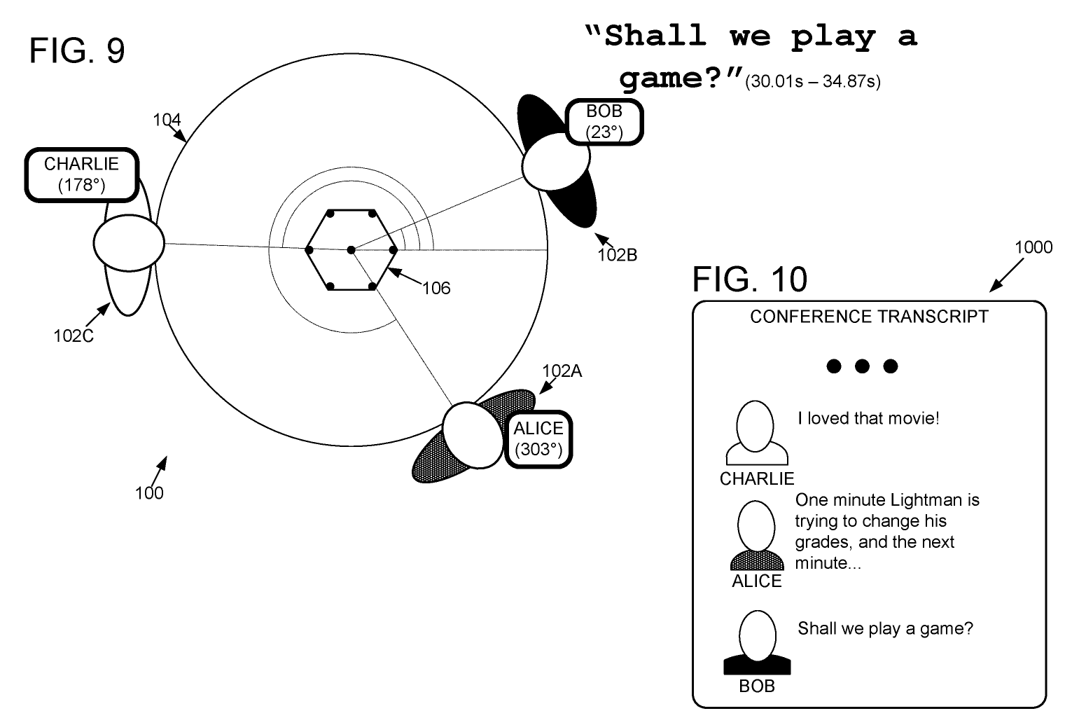

FIG. 10 shows an example conference transcript 1000, which includes text attributed, in chronological order, to the correct speakers. Transcriptions optionally may include other information, like the times of each speech utterance and/or the position of the speaker of each utterance. In scenarios in which speakers of different languages are participating in a conference, the text may be translated into a different language. For example, each reader of the transcript may be presented a version of the transcript with all text in that reader's preferred language, even if one or more of the speakers originally spoke in different languages. Transcripts generated according to this disclosure may be updated in realtime, such that new text can be added to the transcript with the proper speaker attribution responsive to each new utterance.

FIG. 11 shows a nonlimiting framework 1100 in which speech recognition machines 130a-n are downstream from diarization machine 132. Each speech recognition machine 130 optionally may be tuned for a particular individual speaker (e.g., Bob) or species of speakers (e.g., Chinese language speaker, or English speaker with Chinese accent). In some embodiments, a user profile may specify a speech recognition machine (or parameters thereof) suited for the particular user, and that speech recognition machine (or parameters) may be used when the user is identified (e.g., via face recognition). In this way, a speech recognition machine tuned with a specific grammar and/or acoustic model may be selected for a particular speaker. Furthermore, because the speech from each different speaker may be processed independent of the speech of all other speakers, the grammar and/or acoustic model of all speakers may be dynamically updated in parallel on the fly. In the embodiment illustrated in FIG. 11, each speech recognition machine may receive segments 604 and labels 608 for a corresponding speaker, and each speech recognition machine may be configured to output text 800 with labels 608 for downstream operations, such as transcription.

FIG. 12 shows a nonlimiting framework 1200 in which speech recognition machines 130a-n are upstream from diarization machine 132. In such a framework, diarization machine 132 may initially apply labels 608 to text 800 in addition to or instead of segments 604. Furthermore, the diarization machine may consider natural language attributes of text 800 as additional input signals when resolving which speaker is responsible for each utterance.

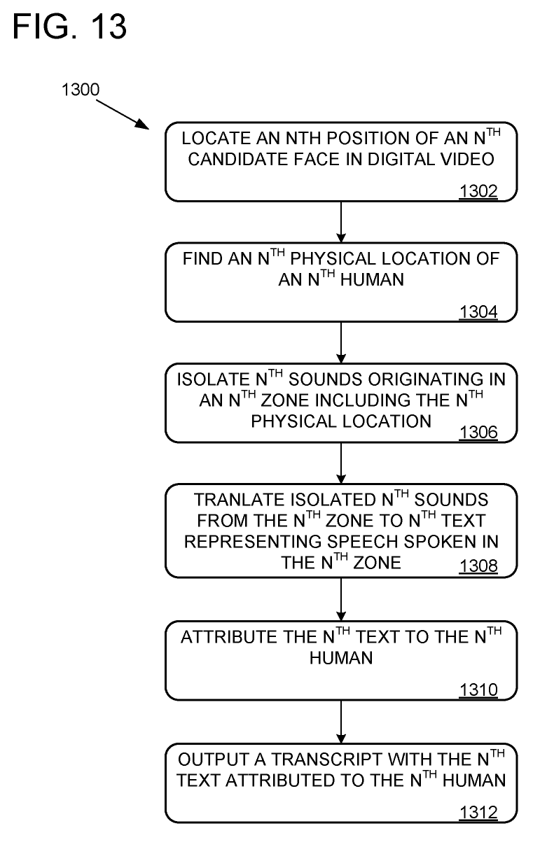

FIG. 13 shows an example method 1300 of attributing speech between a plurality of different speakers. At 1302, method 1300 includes locating an N^{th} position of an N^{th} candidate face in a digital video. As one nonlimiting example, face location may be performed as described with reference to FIG. 4. In some scenarios, more than one face may be located in the same video. In such scenarios, method 1300 may be executed for each potential speaker. In some implementations, parallel execution enables speech to be attributed to plural speakers, even if such speakers are talking over one another.

At 1304, method 1300 includes finding an N^{th} physical location of an N^{th} human. The physical location may be determined, for example, by transforming camera space coordinates of the digital video to world space coordinates of the physical environment. In some implementations, the physical location may only be resolved to an angle relative to the camera. As one example, FACE 1 is found at a physical location that is 23° relative to the camera.

At 1306, method 1300 includes isolating N^{th} sounds originating in an N^{th} zone including the N^{th} physical location. As a nonlimiting example, sounds may be isolated using beamforming as discussed with reference to FIG. 3. Beamforming may be performed in parallel for plural zones, thus enabling plural speakers to be individually heard, even when such speakers are talking over one another.

At 1308, method 1300 includes translating the isolated N^{th} sounds from the N^{th} zone to N^{th} text. The sounds represent speech spoken in the N^{th} zone. As a nonlimiting example, the speech may be translated to text as discussed with reference to FIG. 8. Speech from different zones/locations may be translated in parallel for different speakers.

At 1310, method 1300 includes attributing the N^{th} text to the N^{th} human. Text attribution optionally may be executed in accordance with FIG. 7. As a nonlimiting example, text may be attributed to a human by diarization machine 132. However, in some implementations, text attribution may be based on a single one of face recognition or voice recognition or beamforming zone as opposed to the sensor fusion approach implemented by diarization machine 132. In some implementations, a label indicating a particular identified or unidentified individual may be applied to recognized text and/or an audio signal from which the text is recognized.

At 1312, method 1300 optionally includes outputting a transcript with the N^{th} text attributed to the N^{th} human. FIG. 10 shows a nonlimiting example of a transcript in which text from plural different speakers is attributed to the proper speaker.

Speech attribution, diarization, recognition, and transcription as described herein may be tied to a computing system of one or more computing devices. In particular, such methods and processes may be implemented as a computer-application program or service, an application-programming interface (API), a library, and/or other computer-program product.

FIG. 1B schematically shows a non-limiting embodiment of a computerized conference assistant 106 that can enact one or more of the methods, processes, and/or processing strategies described above. Computerized conference assistant 106 is shown in simplified form in FIG. 1B. Computerized conference assistant 106 may take the form of one or more stand-alone microphone/camera computers, Internet of Things (IoT) appliances, personal computers, tablet computers, home-entertainment computers, network computing devices, gaming devices, mobile computing devices, mobile communication devices (e.g., smart phone), and/or other computing devices in other implementations. In general, the methods and processes described herein may be adapted to a variety of different computing systems having a variety of different microphone and/or camera configurations.

Computerized conference assistant 106 includes a logic system 180 and a storage system 182. Computerized conference assistant 106 may optionally include display(s) 184, input/output (I/O) 186, and/or other components not shown in FIG. 1B.

Logic system 180 includes one or more physical devices configured to execute instructions. For example, the logic system may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic system may include one or more processors configured to execute software instructions. Additionally or alternatively, the logic system may include one or more hardware or firmware logic circuits configured to execute hardware or firmware instructions. Processors of the logic system may be single-core or multi-core, and the instructions executed thereon may be configured for sequential, parallel, and/or distributed processing. Individual components of the logic system optionally may be distributed among two or more separate devices, which may be remotely located and/or configured for coordinated processing. Aspects of the logic system may be virtualized and executed by remotely accessible, networked computing devices configured in a cloud-computing configuration.

Storage system 182 includes one or more physical devices configured to hold instructions executable by the logic system to implement the methods and processes described herein. When such methods and processes are implemented, the state of storage system 182 may be transformed—e.g., to hold different data.

Storage system 182 may include removable and/or built-in devices. Storage system 182 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage system 182 may include volatile, nonvolatile, dynamic, static, read/write, read-only, random-access, sequential-access, location-addressable, file-addressable, and/or content-addressable devices.

It will be appreciated that storage system 182 includes one or more physical devices and is not merely an electromagnetic signal, an optical signal, etc. that is not held by a physical device for a finite duration.

Aspects of logic system 180 and storage system 182 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

As shown in FIG. 1B, logic system 180 and storage system 182 may cooperate to instantiate SSL machine 120, beamforming machine 122, face location machine 124, face identification machine 126, voice identification machine 128, speech recognition machine 130, and diarization machine 132. As used herein, the term “machine” is used to collectively refer to the combination of hardware, firmware, software, and/or any other components that are cooperating to provide the described functionality. In other words, “machines” are never abstract ideas and always have a tangible form. The software and/or other instructions that give a particular machine its functionality may optionally be saved as an unexecuted module on a suitable storage device, and such a module may be transmitted via network communication and/or transfer of the physical storage device on which the module is saved.

When included, display(s) 184 may be used to present a visual representation of data held by storage system 182. This visual representation may take the form of a graphical user interface (GUI). As one example, transcript 1000 may be visually presented on a display 184. As the herein described methods and processes change the data held by the storage machine, and thus transform the state of the storage machine, the state of display(s) 184 may likewise be transformed to visually represent changes in the underlying data. For example, new user utterances may be added to transcript 1000. Display(s) 184 may include one or more display devices utilizing virtually any type of technology. Such display devices may be combined with logic system 180 and/or storage system 182 in a shared enclosure, or such display devices may be peripheral display devices.

When included, input/output (I/O) 186 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

Furthermore, I/O 186 optionally may include a communication subsystem configured to communicatively couple computerized conference assistant 106 with one or more other computing devices. The communication subsystem may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computerized conference assistant 106 to send and/or receive messages to and/or from other devices via a network such as the Internet.

In an example a computerized conference assistant includes a camera configured to convert light of one or more electromagnetic bands into digital video; a face location machine configured to find a physical location of a human based on a position of a candidate face in the digital video; a microphone array including a plurality of microphones, each microphone configured to convert sound into a computer-readable audio signal; a beamforming machine configured to output a beamformed signal isolating sounds originating in a zone including the physical location from other sounds outside the zone based on the computer-readable audio signal from each of the plurality of microphones; and a diarization machine configured to attribute information encoded in the beamformed signal to the human. In this and/or other examples, the face location machine is configured to 1) find a first physical location of a first human based on a first position of a first candidate face in the digital video, and 2) find a second physical location of a second human based on a second position of a second candidate face in the digital video; the beamforming machine is configured to 1) output a first beamformed signal isolating sounds originating in a first zone including the first physical location, and 2) output a second beamformed signal isolating sounds originating in a second zone including the second physical location; and the diarization machine is configured to 1) attribute first information encoded in the first beamformed signal to the first human, and 2) attribute second information encoded in the second beamformed signal to the second human. In this and/or other examples, the face location machine includes a previously-trained artificial neural network. In this and/or other examples, the computerized conference assistant further includes a speech recognition machine configured to translate the beamformed signal into text. In this and/or other examples, the diarization machine is configured to attribute text translated from the beamformed signal to the human. In this and/or other examples, the diarization machine is configured to attribute the beamformed signal to the human. In this and/or other examples, the computerized conference assistant further includes a face identification machine configured to determine an identity of the candidate face in the digital video. In this and/or other examples, the diarization machine labels the beamformed signal with the identity. In this and/or other examples, the diarization machine labels text translated from the beamformed signal with the identity. In this and/or other examples, the computerized conference assistant further includes a voice identification machine configured to determine an identity of a source producing the sound based on the beamformed signal. In this and/or other examples, the computerized conference assistant of claim 1 further includes a sound source location machine configured to estimate a location of the sound based on the computer-readable audio signal from each of the plurality of microphones. In this and/or other examples, the camera is a 360 degree camera. In this and/or other examples, the microphone array includes a plurality of microphones horizontally aimed outward around the computerized conference assistant. In this and/or other examples, the microphone array includes a microphone vertically aimed above the computerized conference assistant.

In an example a computerized conference assistant, includes a camera configured to convert light of one or more electromagnetic bands into digital video; a face location machine configured to 1) find a first physical location of a first human based on a first position of a first candidate face in the digital video, and 2) find a second physical location of a second human based on a second position of a second candidate face in the digital video; a microphone array including a plurality of microphones, each microphone configured to convert sound into a computer-readable audio signal; a beamforming machine configured to, based at least on the computer-readable audio signal from each of the plurality of microphones, 1) output a first beamformed signal isolating sounds originating in a first zone including the first physical location, and 2) output a second beamformed signal isolating sounds originating in a second zone including the second physical location; and a diarization machine configured 1) attribute first information encoded in the first beamformed signal to the first human, and 2) attribute second information encoded in the second beamformed signal to the second human. In this and/or other examples, the computerized conference assistant includes a speech recognition machine configured to 1) translate the first beamformed signal into first text, and 2) translate the second beamformed signal into second text. In this and/or other examples, the diarization machine is configured to 1) attribute the first text translated from the first beamformed signal to the first human, 2) attribute the second text translated from the second beamformed signal to the second human. In this and/or other examples, the diarization machine is configured to 1) attribute the first beamformed signal to the first human, and 2) attribute the second beamformed signal to the second human.

An example method of attributing speech between a plurality of different speakers includes machine-vision locating a first position of a first candidate face in a digital video; finding a first physical location of a first human at least in part based on the first position of the first candidate face in the digital video; machine-vision locating an n^{th} position of an n^{th} candidate face in the digital video; finding an n^{th} physical location of an n^{th} human at least in part based on the n^{th} position of the n^{th} candidate face in the digital video; isolating first sounds originating in a first zone including the first physical location; isolating n^{th} sounds originating in an n^{th} zone including the n^{th} physical location; translating isolated first sounds from the first zone to first text representing first speech spoken in the first zone; translating isolated n^{th} sounds from the n^{th} zone to n^{th} text representing n^{th} speech spoken in the n^{th} zone; attributing the first text to the first human; and attributing the n^{th} text to the n^{th} human. In this and/or other examples, the beamforming simultaneously isolates the first sounds from the first zone and the n^{th} sounds from the n^{th} zone.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computerized conference assistant, comprising:
a camera configured to convert light of one or more electromagnetic bands into digital video;
a face location machine configured to find a physical location of a human based on a position of a candidate face in the digital video;
a microphone array including a plurality of microphones, each microphone configured to convert sound into a computer-readable audio signal;
a beamforming machine configured to output a beamformed signal isolating sounds originating in a zone including the physical location from other sounds outside the zone based on the computer-readable audio signal from each of the plurality of microphones; and
a diarization machine configured to attribute information encoded in the beamformed signal to the human.

2. The computerized conference assistant of claim 1,
where the face location machine is configured to 1) find a first physical location of a first human based on a first position of a first candidate face in the digital video, and 2) find a second physical location of a second human based on a second position of a second candidate face in the digital video;
where the beamforming machine is configured to 1) output a first beamformed signal isolating sounds originating in a first zone including the first physical location, and 2) output a second beamformed signal isolating sounds originating in a second zone including the second physical location; and
where the diarization machine is configured to 1) attribute first information encoded in the first beamformed signal to the first human, and 2) attribute second information encoded in the second beamformed signal to the second human.

3. The computerized conference assistant of claim 1, wherein the face location machine includes a previously-trained artificial neural network.

4. The computerized conference assistant of claim 1, further comprising a speech recognition machine configured to translate the beamformed signal into text.

5. The computerized conference assistant of claim 4, wherein the diarization machine is configured to attribute text translated from the beamformed signal to the human.

6. The computerized conference assistant of claim 1, wherein the diarization machine is configured to attribute the beamformed signal to the human.

7. The computerized conference assistant of claim 1, further comprising a face identification machine configured to determine an identity of the candidate face in the digital video.

8. The computerized conference assistant of claim 7, where the diarization machine labels the beamformed signal with the identity.

9. The computerized conference assistant of claim 7, where the diarization machine labels text translated from the beamformed signal with the identity.

10. The computerized conference assistant of claim 1, further comprising a voice identification machine configured to determine an identity of a source producing the sound based on the beamformed signal.

11. The computerized conference assistant of claim 1, further comprising a sound source location machine configured to estimate a location of the sound based on the computer-readable audio signal from each of the plurality of microphones.

12. The computerized conference assistant of claim 1, where the camera is a 360 degree camera.

13. The computerized conference assistant of claim 1, where the microphone array includes a plurality of microphones horizontally aimed outward around the computerized conference assistant.

14. The computerized conference assistant of claim 13, where the microphone array includes a microphone vertically aimed above the computerized conference assistant.

15. A computerized conference assistant, comprising:
a camera configured to convert light of one or more electromagnetic bands into digital video;
a face location machine configured to 1) find a first physical location of a first human based on a first position of a first candidate face in the digital video, and 2) find a second physical location of a second human based on a second position of a second candidate face in the digital video;
a microphone array including a plurality of microphones, each microphone configured to convert sound into a computer-readable audio signal;
a beamforming machine configured to, based at least on the computer-readable audio signal from each of the plurality of microphones, 1) output a first beamformed signal isolating sounds originating in a first zone including the first physical location, and 2) output a second beamformed signal isolating sounds originating in a second zone including the second physical location; and
a diarization machine configured 1) attribute first information encoded in the first beamformed signal to the first human, and 2) attribute second information encoded in the second beamformed signal to the second human.

16. The computerized conference assistant of claim 15, further comprising a speech recognition machine configured to 1) translate the first beamformed signal into first text, and 2) translate the second beamformed signal into second text.

17. The computerized conference assistant of claim 16, wherein the diarization machine is configured to 1) attribute the first text translated from the first beamformed signal to the first human, 2) attribute the second text translated from the second beamformed signal to the second human.

18. The computerized conference assistant of claim 15, wherein the diarization machine is configured to 1) attribute the first beamformed signal to the first human, and 2) attribute the second beamformed signal to the second human.

19. A method of attributing speech between a plurality of different speakers, the method comprising:
machine-vision locating a first position of a first candidate face in a digital video;
finding a first physical location of a first human at least in part based on the first position of the first candidate face in the digital video;
machine-vision locating an n^{th} position of an n^{th} candidate face in the digital video;
finding an n^{th} physical location of an n^{th} human at least in part based on the n^{th} position of the n^{th} candidate face in the digital video;
isolating first sounds originating in a first zone including the first physical location;
isolating n^{th} sounds originating in an n^{th} zone including the n^{th} physical location;
translating isolated first sounds from the first zone to first text representing first speech spoken in the first zone;
translating isolated n^{th} sounds from the n^{th} zone to n^{th} text representing n^{th} speech spoken in the n^{th} zone;
attributing the first text to the first human;
attributing the n^{th} text to the n^{th} human.

20. The method of claim 19, wherein beamforming simultaneously isolates the first sounds from the first zone and the n^{th} sounds from the n^{th} zone.
